(19) United States
(12) Patent Application Publication
(10) Pub. No.: US 2010/0241620 A1
(43) Pub. Date: Sep. 23, 2010

(54) APPARATUS AND METHOD FOR DOCUMENT PROCESSING

(76) Inventors: Paul Manister, Bristol (GB); Nic Hann, Cardiff (GB); Chris Prosser, Bristol (GB)

Correspondence Address: MCDERMOTT WILL & EMERY LLP, 600 13TH STREET, N.W., WASHINGTON, DC, 20005-3096, US

(21) Appl. No.: 12/738,157

(22) PCT Filed: Sep. 19, 2008
(86) PCT No.: PCT/GB2008/003190

§ 371 Date: Apr. 15, 2010

(30) Foreign Application Priority Data
Sep. 19, 2007 (GB) 0718259.5

(51) Int. Cl. G06F 17/30; G06F 15/16

(52) U.S. Cl. 707/709; 707/748; 709/219; 707/705; 707/E17.108; 707/736

(57) ABSTRACT

A computer implemented document processor comprising: an information capture module configured with an interface to multiple document sources and to capture a plurality of data elements from documents sourced; an interface for receiving objectives and/or criteria; an information processor comprising an assessment module operable to analyse and assess a current state indicated by said data elements; one or more of: a profiles module; a scenario module; and a themes module; a memory; and an output module.

### TECHNICAL FIELD

This invention relates generally to document processing and analysis. More specifically, the various embodiments of this invention relates to the apparatus and methods for searching, capturing, cataloguing and structuring data, and the subsequent methods and apparatus to support automated and human analysis of that data, where the level of automation can be adjusted by the user, depending upon their specific requirements. Typical applications of embodiments of the invention are, for example, to provide ongoing predictive aspects, inquiry, support for decision making and intelligence derivation. Activities supported include but are not limited to; assessment, analysis, ranking, merging, comparing, contrasting, condensing, modelling, reporting and monitoring based on Objectives, Evidence, Profiles, Scenarios and Themes. Moreover, embodiments of this invention are specifically designed to support such analysis and decision making across multiple agencies, by multiple researchers and analysts, utilising multiple criteria and options, with the purpose of supporting senior executives, decision makers, campaign managers and intelligence agencies.

### BACKGROUND OF THE INVENTION

The rapid expansion of information technology usage has resulted in an explosion in the amount of digital information available to the analyst and decision maker in any field or industry, but the shear quantity and diversity of this information has also left a great deal of information inaccessible, undiscoverable or difficult to manage and/or process. Much of this information is textual in nature, subjective, and unstructured, i.e. does not conform to a structure that is easily readable or manipulated by a computer system or other document processing means. In this regard, it can be an inconvenience for the average user wishing to digest small amounts of this type of information, but often a significant problem for larger organisations, seeking to utilise vast quantities of information across a whole manner of different applications. In the latter case, the problem is generally regarded as universal to all undertakings, regardless of industry. Aside from the sheer quantity and complexity of the information presented, no single person in an organisation will see the “whole picture” or, on the contrary, a single person may be in possession of a large quantity of undocumented information, which invariably makes it difficult for others to access this information, let alone achieve a thorough understanding of all information, or be able to see that information from multiple viewpoints in an objective manner. Furthermore, the analyst, or team of analysts, are often not the decision makers in a given organisation, and so communicating the findings and recommendations in a robust and rigorous manner also presents a problem because a significant amount of the analytical effort is usually undertaken by the analyst, backed up by experience alone. No known computer system enables a repeating and/or testing of the analysis against an alternative set of criteria, or new evidence in a rigorous and robust manner.

Unstructured information, as described above, refers to large quantities of data in various formats, for example, text documents, emails, websites, audio and video etc. and includes both factual and subjective data such as press articles, blogs, technical reports and commentary. Structured data, on the other hand, is data which has been processed or formatted in such a way that it can be used efficiently by a computer, or other data processing means, for a variety of useful operations, and generally using as few human resources as possible.

For the purposes of this description, these types of structured and unstructured information should be regarded as different types of documents to be processed.

Currently known document processing technologies most commonly sort through unstructured data by keyword searching, e.g. via an internet search engine. This method typically involves a user entering some relevant search terms into a text field. A search process is then carried out through vast resources of documents, such as web-pages, text archives, emails etc., and a list of those documents, often containing one or more of the specified search terms, is presented to the user in the form of a list or other graphical representation.

An alternative method of processing unstructured data is known as collaborative filtering. According to collaborative filtering, computer systems are configured to make recommendations of relevant data to users based on, for example, their similarity to other users using the same system or network. Usually, this is done by gathering user information from a large number of users. For instance, users may specify their tastes or preferences by filling out a form or alternatively systems may derive preferences from browsing history.

However, current search methods often simply present a user with large amounts of information, often at the complete document level, which may or may not be relevant to the user or their information needs, and which may be cumbersome to navigate. Although current systems can identify documents in which a search term appears, they usually cannot deduce how relevant the document is to the subject being researched because these types of systems simply check for the occurrence of specified keywords. While keyword searching can produce relevant documents, it has many limitations. For example, such systems are not able to decipher whether the concept represented by a search term is related to the overall concept of a document, i.e. they are not able to establish the context of a document. This can have a great impact on the relevance of a given piece of information.

In addition, many methods, particularly keyword-based systems, employ the rationale of ordering the relevance of documents based on the number of occurrences of the keyword or search. However, it is not always the case that the most frequently occurring word in a document defines its relevance. Keyword methodologies also generally rely on the sophistication of the end user to be able to input specific queries, e.g. using Boolean language, which does not always produce desirable results.

There have been attempts to avoid the aforementioned problems by matching concepts within documents, instead of simple keywords. This has generally been done by calculating the probabilistic relationship between multiple variables and determining the extent to which one variable impacts another. Software has then been used to attempt to reveal the context of a piece of unstructured information.

Thus, previously known software approaches have attempted to use mathematical algorithms to decide upon the context of a document or data source. Such approaches use patterns of words occurring within the document or data source, and results are generally independent of the language of the text. These previously known methods have been implemented with the intention of presenting more precise data to the user. However, results produced are often subjective and/or of little or no relevance to a user who is carrying out research in view of specific themes or objectives, and who wishes to use the results of research to make important decisions and take actions. Furthermore, the end result is often that the user is presented with a large quantity of unmanageable information, rather than a smaller quantity of targeted and manageable information. The former is undesirable as it makes using the information, for instance in analysis and decision making, more difficult.

No currently known apparatus and methods are able to capture and organise unstructured data into structured data, and support the analysis of said structured data in a manner that allows an analyst (such as a subject matter expert), or team of analysts, to make full use of that information, compare and contrast their thinking and findings, and then communicate their results to other individuals, for example, the decision makers, in a robust and convincing manner. Furthermore, no known technology contextualises data, accounts for subjectivity according to pre-defined criteria and ranks options and conclusions to support decisions and further analysis. Moreover, no known apparatus or method is able to process data into information valued for its relevance and significance and, furthermore, derive new information pertinent to the user's specific requirements, rather than simply its detail or accuracy in relation to keywords.

Embodiments of the present invention provide a highly organised and objective document data which is accessible to the end user and that is continually updated and relevant to the user's specific needs, even if these needs change over time. Embodiments of the present invention allow, for example, repeatability of analysis for the identification of trends and support trend analysis for the purpose of predicting future situations, and the operating environment of the business.

### SUMMARY OF THE INVENTION

Broadly, embodiments of the present invention provide an evidence based, iterative and integrated process and toolset for the discovery and incremental derivation of new intelligence from unstructured information that seamlessly supports decision analysis and the continuous monitoring of the situational picture across multiple agencies. Embodiments of the inventions relate to the apparatus, methods and computer code as set out in the appended claims.

### BRIEF DESCRIPTION OF THE DRAWINGS

For a better understanding of the invention and as to how the same may be carried into effect reference will now be made, by way of example only, to the accompanying drawings, in which:

FIG. 1 is a diagrammatic representation of the iterative and integrated nature of the underlying process and activities that occur throughout the application of embodiments of the present invention;

FIG. 2 illustrates a system according to one embodiment of the present invention divided into four sub-systems;

FIG. 3 is a schematic illustration of an embodiment of a document processing system according to the present invention;

FIG. 4 shows a more detailed illustration of the document processing server 302 according to an embodiment of the present invention;

FIG. 5 shows one example of how unstructured data is structured according to an embodiment of the present invention;

FIG. 6 illustrates a typical process in which profiles are populated according to an embodiment of the present invention

FIGS. 7A-F show various types of profiles used in embodiments of the present invention;

FIG. 8 illustrates one example of an assessment scheme cluster of themes comprising criteria used to monitor a rapidly changing situation according to an embodiment of the present invention; and

FIGS. 9A-C show an illustrative example of how the data produced by an embodiment of the present invention may be used in business decision making.

### DETAILED DESCRIPTION

Those skilled in the art will appreciate that while this disclosure describes what is considered to be the best mode and, where appropriate, other modes of performing the invention, the invention should not be limited to the specific configurations and methods disclosed in this description of the preferred embodiment.

In order to gain an appreciation of the whole invention when reading the detailed description, it is first useful to understand the underlying functions and processes of the embodiments of the invention, end to end, although it should be noted that the processes described herein are generally iterative and cyclical, as long as the need for the outputs remains valid.

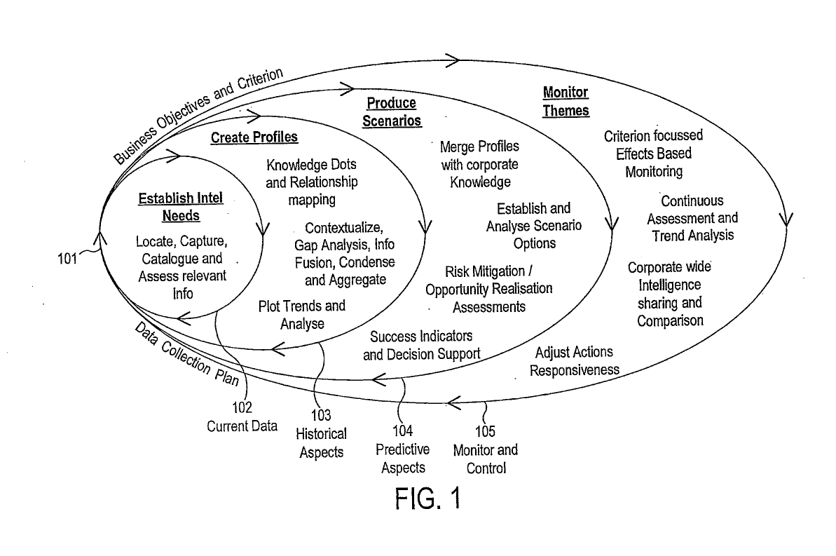

FIG. 1 shows a graphical representation of one process according to an embodiment of the present invention, complete with the sub-processes and analytical tools that prevail within each stage of the iterative cycle. It should be noted that each circle in the process is connected at the same point 101, which represents the initial data collection point in the iterative process cycle. To simplify the understanding of the process, it will be described here as a means to ascertain, assess, analyse and react to situational pictures, whether those pictures are set in the past, present or future. In practise, however, this situational picture could be anything from a complex description of an operating environment on a global scale, down to a minute study of a single event from different perspectives.

At the highest level, the system process can be broken down into four sub systems, each with a defined output. These sub-systems are termed “modules” and are as follows; Evidence Assessment Module (for Current Data) 102, Evidence Analysis Module (for Historical Aspects) 103, Decision Support Module (for Predictive Aspects) 104, and Trend Analysis Module (for Monitor and Control) 105. Each sub-system is described in turn in the following paragraphs.

Each of the sub-processes may be self contained and may be operated independently of other processes, or as an integrated set where inputs and outputs are all interlinked to each other in any order. For instance, themes can be created and monitored without the creation of scenarios or profiles if, for example, trend information is required for academic reasons, rather than for business controls. The component that links all the sub-processes together is the information processor 406, where links to the evidence can be configured and controlled as desired. In this regard, each of the modules may be regarded as a sub-process of the information processor 406, implemented either in hardware, software or a combination of both.

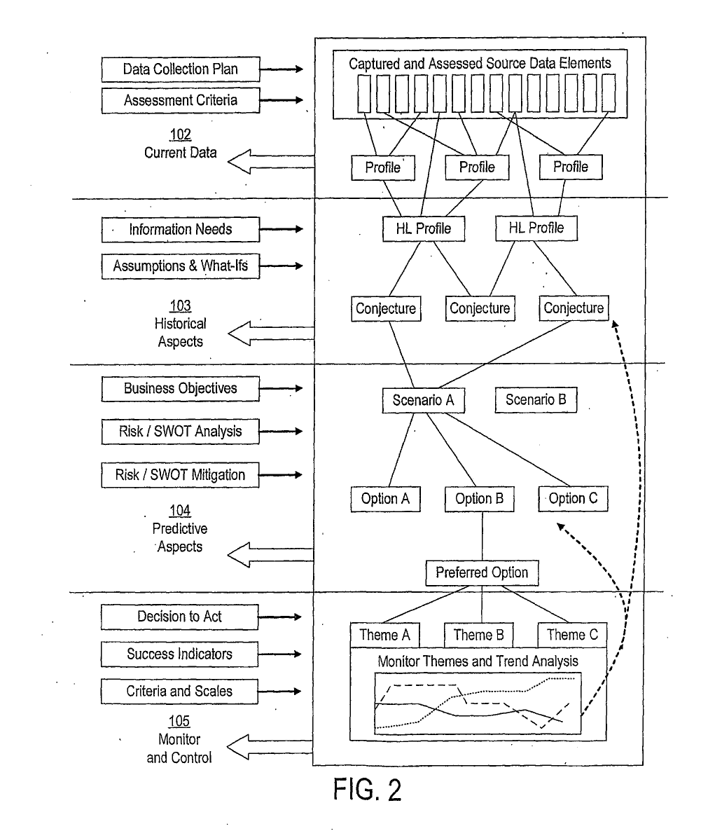

FIG. 2 shows a more detailed breakdown of each of the sub-systems, or modules, and shows: Evidence Assessment Module (for Current Data) 102, Evidence Analysis Module (for Historical Aspects) 103, Decision Support Module (for Predictive Aspects) 104, and Trend Analysis Module (for Monitor and Control) 105. Data output from each of the modules 102, 103, 104 and 105 may be stored in a local datastore, for example a non-volatile memory, residing on server 302.

### 102 Evidence Assessment Module (Also Referred to as “Sub-System 1”)

Purpose of Evidence Assessment Module: To manage Current Data. This module is configured to provide a detailed understanding of what is happening, or has happened, based on an assessment of the evidence collected and the establishment of simple profiles against criteria. Another example of its purpose is to assess the mood and impact of the situation on current operations and activities, and identify the key players and their relationships with each other.

Inputs to Evidence Assessment Module: A Data collection plan (for instance information needs, search criteria, and relevance criteria etc.), for instance, to point a search engine in the right direction with the vast reservoir of open source information, and the data Assessment Criteria based on key messages, areas of interest, ranking and scoring scales etc. Also, closed source information such as internal reports, plans and documents.

Functions of Evidence Assessment Module: To identify, locate, capture, organise, and catalogue source material, and then split that material down into data elements, which may be sections within a document, whilst maintaining associations to all of the above for each and every data element. This source data may then be used for detailed assessment against the criteria inputted or set in advance one by the user to further catalogue each data element and produce profiles or “dots of knowledge” that are of specific interest to the user. In the context of the present invention, a “dot of knowledge” is used to refer to a profile comprising at least a single element of data, which will be described in more detail below.

Outputs of Evidence Assessment Module: Current Data is achieved through the analysis of the results of the source data assessment functions aided by visualisation techniques of the assessment results, including, for example, a dynamic timeline of events and other media reporting that enables thread analysis and assists in the identification of causes and effects. Another output, according to one embodiment, is dynamic and animated proliferation maps that show the spread of media reporting across the globe over time including impact assessments and links to other cataloguing information such as impact on reputation scores.

Level of Automation of Evidence Assessment Module: It is a feature of sub-system 1 that it can be configured to be highly automated, responding to the criteria inputted by the user, but with a manual override capability where the user can determine the level of automation required. The assessment process is ongoing at all times, such that the outputs are continually updated to provide the user with near-real time intelligence, but in such a way that the changes to the knowledge can also be tracked to produce change plots to further enhance the value of the derived information.

The disclosed embodiment benefits from a further facility for the user to record ideas, observations and notes alongside the evidence and automatically generated “dots of knowledge” so that facts and opinions can be separated and controlled by human intelligence. Irrelevant information can also be removed to improve the value of the assessed data.

The Evidence Assessment Module 102 is foundational to the whole process and an integral component of the other sub-systems because this is the module that holds the source material and evidence that the other sub-systems use to derive their information. The data collection plan, which is an input to sub-system 1, is informed by the outputs and information needs of the other sub-systems, which is described below.

### 102 Evidence Analysis Module (Also Referred to as “Sub-System 2”)

Purpose of Evidence Analysis Module: To manage Historical Aspect data. This is a further development of the understanding achieved from sub-process 1, involving placing the derived information into the historical, operational and environmental context of the problem being solved, in order to establish why things are happening, or did happen. Historical Aspect data also presents the understanding achieved from sub-system 1 from different viewpoints to provide a better appreciation of the situation.

Inputs to Evidence Analysis Module: There are two key inputs to sub-system 2, in addition to the outputs of sub-system 1. These additional inputs are: specific information needs or examination questions to be answered in order to fill in the gaps in knowledge (i.e. analysis criteria), and/or any assumptions introduced to the analysis effort by the user.

Functions of Evidence Analysis Module: Functions include the joining up of profiles/“dots of knowledge” to identify and establish relationships, and high level profiles pertinent to the user. Other functions include the analysis, investigation and inquiry of known facts, knowledge gap analysis and the contextualisation of the information by, for instance, relationship mapping, and further assessment of the derived knowledge against user defined criteria. The management of assumptions is also a key function of sub-system 2, to ensure facts and conjecture are kept separate but interlinked.

Outputs of Evidence Analysis Module: Historical Aspect data is achieved by combining low level profiles into high level profiles that are specifically aimed at resolving the user's information needs. Where facts are uncertain, or unknown, assumptions can be included to create conjecture to test the knowledge accrued in a manageable way. Identified gaps in the knowledge can be fed back into Sub-system 1 as updates to the data collection plan. Visualisation techniques to aid analysis and reporting, e.g. dynamic relationship mapping, are also important outputs.

Level of Automation of Evidence Analysis Module: The level of automation in sub-system 2 is high but performance can be enhanced by manual manipulation to ensure the analysis remains relevant and targeted at all times. Relationship mapping amongst the profiles established in sub-system 1 can be highly automated but the introduction of assumptions and “what-ifs” usually involves some degree of human interaction.

The purpose of sub-systems 2 and 3 is to provide a toolset for a data analyst, or even dispersed teams of analysts, where a lot of research effort is undertaken automatically. As with sub-system 1, the process is iterative to keep the results constantly up to date and relevant, whilst being able to track the changes in knowledge over time. Human intervention is possible during the automated processes to keep the results focussed, succinct and relevant.

### 103 Decision Support Module (Also Referred to as “Sub-System 3”)

Purpose of Decision Support Module: To manage Predictive Aspects, i.e. to know how to act, or react to a situation such that the maximum benefit is realised, or risks (and their impacts) are minimised. In other words, managing Predictive Aspects is about acting correctly, and/or shaping future actions ahead to suit particular needs.

Inputs to Decision Support Module: This is where the objectives of the business are, introduced to the analysis and merged with the outputs of sub-systems 1 and 2 to enable scenario based modelling. Additional user defined inputs are also required to undertake risk based analysis, option analysis and decision support. The outputs of Sub-system 3 will constantly keep the scenarios and action plans relevant and focussed.

Functions of Decision Support Module: The key functions of Sub-system 3 is to build and test scenarios against the business objectives, model risks, SWOT analysis, derivation of options and mitigation plans, undertake analysis of those options, and finally provide support to the decision making process through multi-criteria and multi-agency assessments and other selection techniques.

Outputs of Decision Support Module: Introducing Predictive Aspects is achieved by taking the Historical Aspect data and merging it with business objectives to develop future scenarios complete with risk mitigation and/or opportunity exploitation plans. Predictive Aspect data enables the right decisions to be made and timely actions to be taken and so a key component of sub-process 3 is an options analysis and decision support tool.

This includes, for example, scenario descriptions, managed risks, auditable decisions based on option analysis, and the identification of measurable success indicators and warning signs to support sub-system 4. The output can best be described as a business case for the way forward or desirable next steps. It may include success indicators and warning signs.

Merging Predictive Aspects with business objectives benefits from creative thought and business acumen to establish the strategic direction of business or the roadmap to the desired goals. Within this, the module automates administrative aspects of ensuring the right decision is taken in a robust and rigorous manner, and so this burden is removed. In other embodiments, expert engines (for example artificial intelligence computer systems) may replace human inputs to this embodiment.

Sub-system 3 is configured for the development and management of business cases prior to making the decision. A feature of sub-system 3 is the use of the outputs from sub-system 4 to ensure the actions taken continue to be effective in an ever changing environment, and, if not, develop alternative plans to keep the actions focussed on the realisation of the goals.

### 104 Trend Analysis Module (Also Referred to as “Sub-System 4”)

Purpose of Trend Analysis Module: To enable Monitor and Control. This is to know whether the actions taken, or decisions made continue to be effective, and to know when to change direction or stop activities due to changes in circumstances, the environment and/or political sensitivities, for example.

Inputs to Trend Analysis Module: The success indicators and/or warning signs identified from the planning activities in sub-system 3 are translated into independent Themes to be monitored. Scoring scales and assessment rules also need to be inputted to ensure the monitoring activity is properly managed. Such scoring scales and assessment rules include, for instance, periodicity of scoring, scoring panel structure, and sub-criteria bound to each Theme.

Functions of Trend Analysis Module: One key function of sub-system 4 is to monitor specific topics of interest in a measurable way and produce trend graphs for each Theme that can be compared and contrasted with each other to derive meaningful conclusions. Another function is reporting outcomes to inform Scenario development and the effectiveness of mitigation plans and realisation plans already in place.

Outputs of Trend Analysis Module: This process enables themes (in other words ‘topics of interest’) to be created, monitored, scored and assessed over time to provide trend information that can be compared and contrasted. By selecting the themes carefully to focus on success indicators and/or warning signs derived from the plans developed in sub-process 3, it is possible to detect early changes to the situation and operating environment, monitor progress, and identify causes and effects through the analysis, of trend information.

Level of Automation of Trend Analysis Module: Once set up by the user, the level of automation is high in that evidence for the Theme can be obtained in the same way as for sub-system 1 and presented to the analyst for human assessment and scoring. Further automation can be achieved, if required, to allow the system to derive its own scores if appropriate. The level of automation can be varied according to the user's specific needs. Indeed, each Theme being monitored could have its own level of automation set depending upon its importance or criticality to the overall criterion or purpose of the monitoring activity.

Themes will ideally be neutral to the user such that observations and scoring is not tainted by the question being examined. For example, a collection of Themes can be used to monitor a particular Scenario, and a single Theme can be used to monitor more that one Scenario if it is carefully defined.

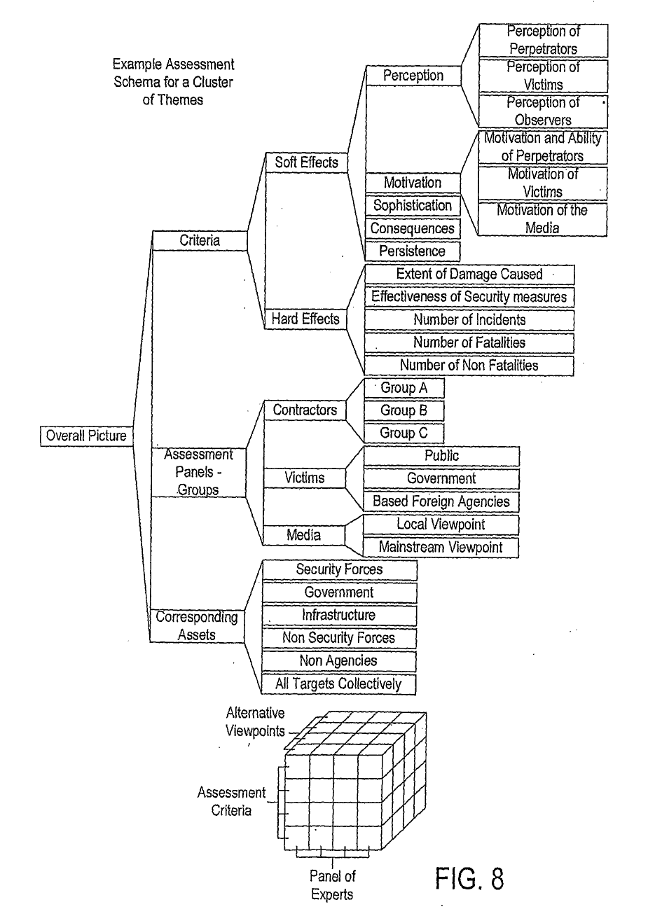

FIG. 8 is an example of a comprehensive set of Theme's that can be used to support the real or near real time analysis of a large number of perspectives on a particular situation, in this case, the effects of an explosion at a refinery. Other uses could include, but not limited to, Internal business monitoring across departments, areas, functions, products etc, or corporate reporting where assessments are aggregated and condensed for senior management consumption, but with the ability to ascertain further evidence detail in any area if so desired.

FIG. 2 illustrates an example of an end to end process carried out according to an embodiment of the present invention, where the whole process has been divided into the four sub-systems described above. In summary, the end to end process steps are as follows, however, it should be noted that this list is for illustrative purposes and does not constitute an express limitation:
Identify and capture relevant information;
Catalogue and Assess it against user defined criteria;
Break the data down into useful elements keeping the links to the associated meta-data;
Create Profiles (dots of knowledge) based on user's specific information needs and link to data elements (evidence);
Create High level Profiles to join the dots of knowledge up and establish relationships based on what is known;
Introduce assumptions to the High Level Profiles to create Conjecture;
Group Conjecture together to establish Scenarios (using alternative assumptions to create alternative Scenarios);
Test the scenarios against business objectives (Risk Assessment and SWOT Analysis etc.);
Establish Mitigation Plans and/or action plans and Decide on preferred course of action;
Identify Success Indicators and/or Warning Signs;
Establish Themes around the Indicators and monitor their developments continuously to produce Trend Graphs; and
Compare and contrast Trends to provide feedback to Scenarios and support ongoing decision making.

At all points in the process, information gaps are established and the results may be fed back into the data collection plan, i.e. at point 101 (see FIG. 1). Each stage of the information development is linked to each other in a controlled and systematic manner to ensure full traceability back to source data and sub elements of the overall knowledge base.

Profiles are maintained to be current if relevance is high, or set to be dormant waiting for regeneration at a later date if required.

The whole process is designed to be delivered by multiple operators unconnected to each other, as well as a single operator acting alone. Furthermore, the relationships between Profiles, Conjecture, Scenarios and Themes are many-to-many, such that one dot of knowledge, for instance, can be used many times to support multiple scenarios, or a Theme may be used to monitor the progress towards achieving multiple scenarios, etc. The various ways in which Profiles, Conjecture, Scenarios and Themes may be linked will be evident to the skilled person upon reading the following description.

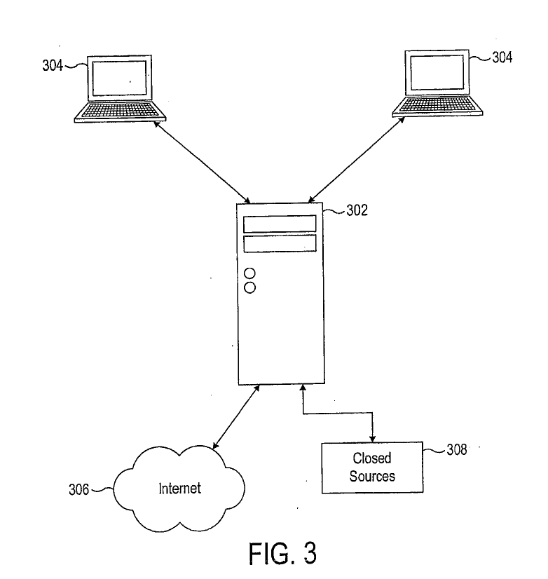

FIG. 3 is a schematic illustration of an embodiment of the document processing system according to the present invention. The processing system comprises: a data processing server 302 and one or more remote access devices 304, or access terminals.

The server 302 is operable to source unstructured data from a variety of ‘open’ sources. ‘Open’ sources in this context refers to data which is freely available to the general public, including but not limited to: web pages on the internet 306, news reports, scientific journals and such like. The server is also configured to source data from ‘closed’ (or internal) sources 308. In this context, ‘internal’ sources refers to data which is not freely available to the general public and is typically data such as internal company reports, business (or other) plans, emails, correspondence etc. This closed, internal data also encompasses data generated by the server 302 itself in the form of data feedbacks and exchanges between the various modules as described above, which are not made available to the public. One such example of internally generated data is profile data, which will be explained in more detail below.

As will be evident to the skilled person, the type of data that can be processed by the server 302, according to the various embodiments of the present invention, is not limited only to text documents. The server can also process alternative sources of data such as photographs, videos, audio clips or other types of digital media, whether held within a local database or stored at some remote site or data store. For the purposes of this description, all such data are regarded as types of documents. Where data is not held locally in a database (or other data store) residing on server 302, it is most typically accessed by an appropriate link, for example, over the Internet via a URL pointing to the relevant address to retrieve the content.

The one or more remote access device 304 is used to download, upload, manipulate and/or view data on the server 302. Typically, the remote access devices are desktop computers, PDAs, Blackberry devices and such like, which are equipped with standard web browsers or are provided with an application for communicating with the server 302. Alternatively, the remote access device may be a terminal connected directly to the server 302 for data transmission. Optionally, the server 302 also has an interface application programming interface [API] (not shown) for communicating with one or more similar servers for the sharing and conglomeration of data across numerous platforms. According to one embodiment, the functionality of the server 302 may be implemented in software and run on a suitable electronic device such as a desktop computer.

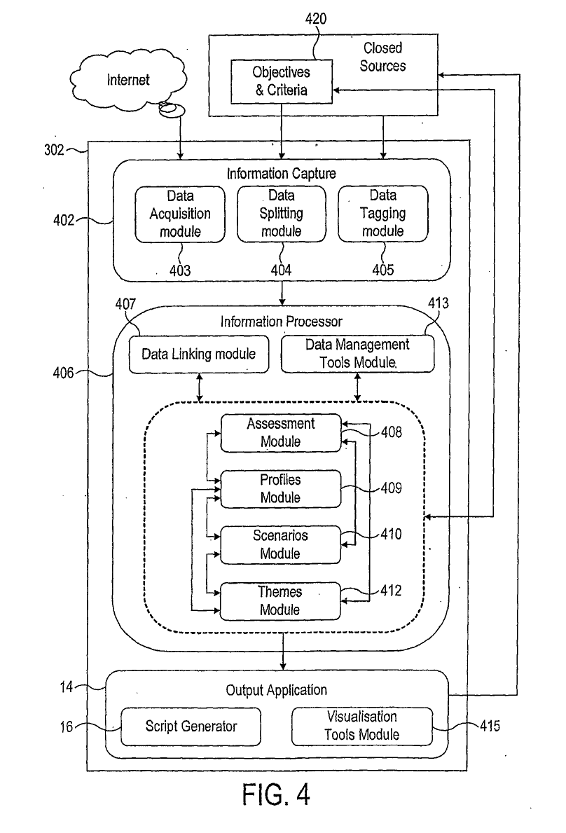

FIG. 4 shows a more detailed illustration of the document processing server 302 according to an embodiment of the present invention. The server 302 comprises an information capture module 402, an information processor 406, and an output application 414. The server 302 also comprises a datastore (not shown), which may be a non-volatile memory or otherwise, logically connected in order to store data outputs, for example, data elements, profiles, scenarios, themes etc., from different parts of the server 302.

The information capture module 402 is configured for data input and management, and is operable to acquire (via a data acquisition module 403), organise (via data splitting module 404), and catalogue (via data tagging module 405) source data for facilitating subsequent information processing. According to an embodiment of the present invention, data is typically sourced according to one or more predefined objectives and/or criteria 420 and is therefore specific to a data collection plan or other predefined criteria, e.g. business needs or business objectives. In this sense, the data acquired is specific to a user's needs, as was described above.

The information capture module 402 comprises a data acquisition module 403. This module 403 is configured to be the main input interface to the system, and under normal operation of the server 302, a system operator will import all documents via a graphical user interface (GUI) using this module. The unstructured data may be acquired from any source; whether it is open sources e.g. the internet 306, or other publicly available media, or closed sources 308 such as company records, plans, memos, emails and such like. Further examples of data sources which can be placed in either information category are client-provided information or even unverified information such as word of mouth information (hearsay) which can be manually entered into the system by an operator.

The data acquisition module 403 enables the system operator to specify the nature of data to be imported—that is, to define whether the information is ‘closed source’ or ‘open source’. This is advantageous in that it allows for the definition of access permissions in relation to the data. In other words, different users may be given access to different data based on one or more configurable user account-based access permissions.

The collection and presentation of information from the internet (to the data acquisition module 403) at this stage may be done automatically or manually by an operator of the system (such as a subject matter expert), or a combination of both. According to one example, the data acquisition module 403 utilises ‘web-crawler’ technology configured to gather data specific to one or more predefined objectives 420 by browsing, downloading and indexing web-pages automatically. Alternatively, or in addition to this process, a system operator may conduct his or her own internet searches using standard web-browser technology. In the latter case, the data of interest collected at this stage is recorded in, the data acquisition module 403, for example via a browser extension, that is, a piece of code which executes within the browser environment allowing the data to be sent directly to the module 403. Where the data is automatically acquired by the information processor, an operator of the system may choose to check the data generated in order to verify its relevance, accuracy and suitability in view of the objectives 420. Most typically, a system operator is a subject matter expert with the knowledge and skill to acquire the relevant data and perform the necessary operations on that data. However, this may or may not be the case, depending on the type of application of the server 302. In certain embodiments, the manual actions and selections of a subject matter expert may be replaced by one or more expert engines.

In general terms, the information capture module 402 takes unstructured source data from any of the above-mentioned sources and performs one or more structuring operations on the data in order to give it a useable structure. This data structure can then be recognised and used by all other components of the data processing server 302.

For this purpose, the information capture module 402 further comprises a data splitting module 404 operable to split documents, or other sources of data, into predetermined constituents, as well as to define and label the various constituents of the source according to a predefined structure or template. This may be done automatically by the system, manually by an operator of the system or a combination of both.

According to an embodiment of the present invention, the data splitting module 404 is deployed with a processor for running operation code which is able to analyse sentences within text documents and identify for instance noun, verb, and subject syntax. This is most typically done using Natural Language Parsing (NLP) code or another computational linguistics method. Embodiments of the invention may use more advanced computational techniques to split and structure the data at this stage, for example, Artificial Intelligence (AI) techniques, including document fingerprinting and heuristics.

Alternatively, an operator or subject matter expert may perform manual tasks using the information capture module, such as checking and verifying the output from the information capture module before it is processed any further in the system. An operator may also manually split documents or other data sources into predetermined constituents by reviewing a text document and splitting the text down to paragraph and sentence level according to preference, based on objectives 420 or other criteria. In any event, the result of processing through the data splitting module 404 is that unstructured data is split into smaller discrete ‘elements’ of data according to predefined rules.

The information capture module 402 also comprises a data tagging module 405. This module 405 is used to define and label the various attributes of data sources. This process may be generally defined as ‘tagging’. According to embodiments of the present invention, attributes (or metadata) such as the date, time, source of the document and keywords such as geographic locations, organisations and such like can be automatically defined and tagged to each element of the source data (produced by the data splitting module 404) by the data tagging module 405. This is a done by a processor using specifically deployed code which is operable to search through a data source and ascertain any kind of attribute metadata. A known example of this kind of code is the Gnosis application provided by ClearForest Corp., but other examples of text-mining code may also be used according to aspects of the present invention. Additionally, constituents of the source document may be labelled to define other predetermined attributes, for example, the context of a story or article, rather than simply the tagging of keywords appearing within the story or article. The process can be carried out by a manual operator of the system, such as a subject matter expert, or an expert engine. It is also possible for an operator, or an expert engine, of the system to enter a keyword summary or other commentary for instance an opinion, hypothesis or instruction to further improve the categorisation of metadata using one or more custom data fields.

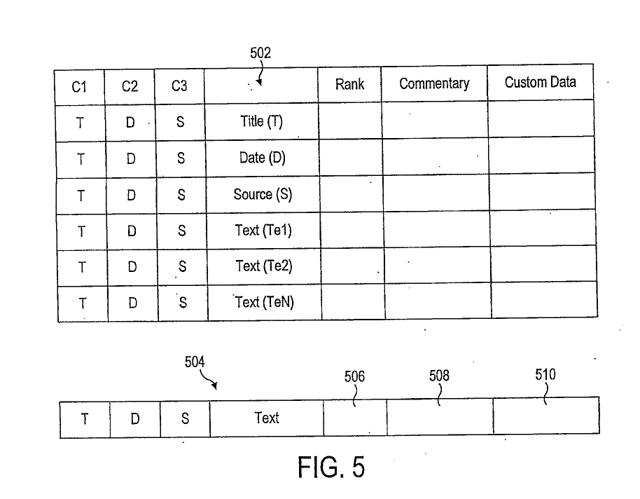

FIG. 5 shows one example of how unstructured data from a variety of different documents sources can be structured according to embodiments of the present invention. A source document (e.g. a HTML web page, Word document, PDF or such like) 502, is selected and inputted into the information capture module 402 (via the data acquisition module 403) in accordance with one or more objectives 420, i.e. an overriding business objective, a data collection plan, or in view of an output from another module of the system. The data source is split into elements by the data splitting module 404 and then catalogued further via data tagging module 405 using one of the methods described above. In FIG. 5, for example, the document attributes of title (T), date (D) and source (S) are all identified and marked, either automatically by the module, or manually by an operator. Other examples of attribute data are author, news source, web address and so forth. In this example, the attributes are structured according to a relational template which has columns C1-C3 representing predetermined category classes, where C1 corresponds to the title T, C2 corresponds to the date D of publication and column C3 corresponds to the source S of the document. Once T, D and S have been defined and tagged in the source document, they are automatically copied across into the fields C1-C3 respectively by information capture module 402, for any number of rows. The rows in this example represent sections of the text within the document. In this example, Te1-TeN could represent, for instance, separate items or facts within the same document 502. It should be noted that any number or type of document attributes or any type of relational structuring may be used according to embodiments of the invention, the present example being provided only to illustrate one possible application.

Following on from the given example, the combination of T, D, S and Te forms a data element 504. The data element 504 is logically associated with the original source by one or more suitable links pointing to the original source. In other words, source documents can be broken down into smaller, elemental constituents, where each element automatically inherits attributes of the parent.

Preferably, a copy of the data element and original data source is stored in a datastore on the server 302, or other remote data store, and is accessible through the one or more links associating the data element 504 with the original data source. The data element constitutes structured data and comprises, for example, data fields for title, date and source address of the original data source, and additionally has a media component (such as Te) corresponding to a portion of the original source of the media 502. In general terms, a data element contains at least one data field which is populated with any attribute information (metadata) and any content from the unstructured source document.

Broadly, the information processor 406 is capable of performing a whole manner of processing tasks on data elements, including but not limited to: merging; linking; searching; filtering; sorting; and other organisational operations. Additional functionality of the information processor 406 enables determining the context of structured data and rating it based on relevance. In other words, the information processor 406 is operable to take a data source as an input (generally from the information capture module 402), decipher its meaning and define its relevance based on predefined criteria. Typically, relevance or importance to a particular need is rated in view of the objectives 420, but other predefined criteria such as feedbacks from profiles, themes and/or scenarios (as described below) may also be used either independently or in combination with the objectives 420 to identify additional key data elements applicable to the information needs of the user.

Referring again to FIG. 4, the information processor 406 is operable to take structured data output from the information capture module 402 as an input. Typically this will be the one or more data elements 504 taken directly from the information capture module 402 (or from a datastore on the server 302), as described above, but it may also take pre-structured data feedbacks from one of the other modules of the server 302, as contained in the dotted box in FIG. 4.

The information processor 406 is operable to allow human interaction via a user interface module (not shown) as part of the data management tools module 413, as and when desired, e.g. to capture thoughts, record uncertainties and identify knowledge gaps etc., to ensure the results remain correct and meaningful.

The information processor 406 is operable to perform the aforementioned tasks on data, taken from both open and closed (or internal) sources, so long as it has been structured in the appropriate format (for example see FIG. 5). The information processor 406 is thus able to merge data taken from both open sources, such as the internet, and closed sources, such as information internal to a business or organisation, and identify and highlight relationships based on the context of the documents, and/or one or more pre-defined objectives 420. According to one aspect of the invention, a clear separation between open source and closed source information is always maintained to enable, for instance, an analyst to determine what other individuals might know, and/or what the user knows that other individuals will not know.

According to a preferred embodiment of the invention, the component parts of the information processor 406 are; data linking module 407, data management tools module 413, assessment module 408, profiles module 409, scenarios module 410 and the themes module 412. Each of these is explained in more detail below. It in this embodiment, each component part, 413, 408, 409 and 412, is designed to be capable of independent operation, with each component utilising the evidence captured in the information capture module 402, and drawing upon the tools as appropriate from the data management tools module 413. A user can mix and match the capabilities required for the purpose of the intended application, or add to the capability of the system by selecting which modules are active/not active at the appropriate time as required. The user may also introduce additional modules configured for specific applications as required. For instance, a legal support team may not require the use of the Themes module when preparing a legal argument, and may not require the full functionality of the Scenario model, depending on the specific details of the application. In other words, according to one embodiment, the user is only be presented with the tools required to perform a specific task, or number of tasks, in order to keep the interface simple and application-specific.

The information processor 406 comprises a data linking module 407 operable to link individual data attributes from different data elements according to a set of predefined profiling rules. Thus, according to one aspect of the data linking module 407, it is possible to create associations between unconnected data elements under a new, overarching heading. The data linking module 407 is designed to manage all the links between data elements and objects of derived information (profiles), and between all derived information objects in accordance with pre-defined rules, to ensure traceability is constantly maintained back to the source data or evidence. These links will also enable attribute information to be viewed across modules and profiles to provide “360 degree” reporting, in other words reporting from different perspectives or viewpoints. The links can also be analysed to provide filtered views that show impacts and traceability in a similar manner to other object orientated databases. The data linking module 407 also provides functionality to traverse links of data elements in order to arrive, eventually, at the source data element, document or content item for any given profile, scenario or theme.

The Data Management Tools Module 413 comprises a suite of tools designed specifically to manage information. In addition to the filter, sort, and searching capabilities that are standard features to most databases, the Data Management Tools Module 413 includes specialist data management tools. These specialist data management tools may be used for a number of purposes, however, according to one embodiment, they are used for risk analysis. In this case, the management tools are operable to manage a risk/opportunities register and support risk analysis. The Data Management Tools Module 413, according to one embodiment, further comprises decision support tools that enable various multi-criteria decision analysis techniques to be undertaken, such as Multi-Attribute Choice Elucidation (MACE) and Pairwise comparison to support option analysis. This module also includes function code for assumptions Management, continuous assessment and monitoring, trend tracking and analysis, scenario modelling and planning tools each designed for a particular information processing module, as described below. A further embodiment of the data management tools module 413 facilitates communication and interaction with other existing data management tools to provide specialist analysis, modelling and information management using established software and techniques already in widespread use by, for instance, project management and industry. An import and export tool to other databases and applications, in various formats, is also a feature of this module, in order to maximise existing corporate capability and know-how.

It is a further feature of embodiments of the present invention that a record of actions carried out by the server 302 is kept over time. In this regard, any changes made to data are stored in a separate data file or log (which is stored, for example, in the datastore of the server 302), which enables an operator of the system to ascertain what changes have been made over time. The data stored in such data files may be used by the system in order to carry out automatic processes at various stages or to reverse amendments made to data.

The structured data elements created by information capture module 402 can be further processed by the Assessment module 408 by introducing user-specific criteria and scores that are specific to the user's information needs and objectives. For instance, a document, or data element, can be rated according to relevance, reliability or impact on perception or any other subjective scale that would be of interest to the user.

Referring again to FIG. 5, according to an aspect of the invention, a numerical ranking is placed in a rank data field 506, which is automatically copied to any other associated data element, if appropriate, and used to generate statistical reports to aid further analysis and support profiles (explained in more detail below). Alternatively, a non-numerical ranking system may be used, e.g. using terms such as “Good”, “Neutral”, “Bad”, or the tagging of key messages the user wants to track to data elements based on the user's specific information needs. Optionally, user comments or notes may be written into the commentary field 508, e.g. a comment relating to what is known or thought about a given data source, or any instruction to an operator of the system to manually adjust the data collection criteria to provide better targeted information in order to substantiate the data in the data element fields or attributes in view of the objectives. Any other data may be written into one or more custom data fields 510 as required with that meta-data being assigned automatically to associated data elements as required. The assessment of the data captured is undertaken alongside the captured data so that it can be easily revisited and will also become part of the data element's meta-data set.

Connected data elements and the linked data constituents form a new hybrid data source, which is referred to throughout as a ‘profile’ and will be described in more detail below. ° Thus, in this way, data elements that share a common criterion become linked to a new data element (or object) where the common criterion can be further explored and assessed.

The data output from the Assessment Module 408 may be fed into the profiles module 409, which is operable to use the data from the information capture module 402 and assessment module 208 to populate one or more profiles. A basic construct of a “profile”, in this context, is simply an object of information (including a number of attributed values), which is linked to supporting evidence (one or more data elements). This basic construct makes the process simple to manage and control. In this way, the data linking module 407 may be controlled, at least in part, by the profiles module 409, which determines how certain data elements 504 should be linked according to a given profile type or category to produce “Dots of Knowledge”.

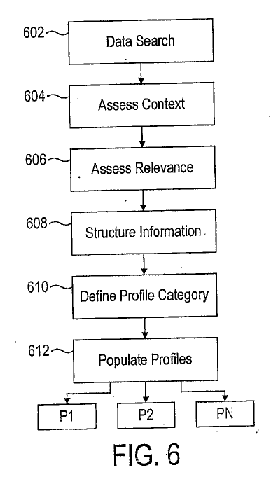

FIG. 6 illustrates a typical process in which profiles P1 to PN are populated according to certain embodiments of the present invention. In this exemplary process, one or more predefined profiles are created utilising one or more of the modules described above. For example, a targeted text search is performed 602 to gather data from the internet 106 using a search engine based on one or more objectives 420. The search results, which are produced by the search engine, are assessed to ascertain whether they are contextually correct 604 according to the one or more objectives 420, and whether they are appropriate for the profile which is intended to be populated. As an alternative, data may be gathered based on existing profile, scenario or theme data (or based on gaps identified in existing data) as has already been described. For example, in the case where a profile is intended to factually describe an individual, it is preferable to filter out information which contains the correct keyword (i.e. the individual's name) but does not have the correct context, e.g. an opinion of the individual written in a blog which contains little or no factual data. The contextually correct data is then assessed according to its relevance 606. Following the same example, a data source such an official biography on the individual may be considered by the system to be highly relevant, whereas the written opinion in the blog may be considered by the system to be less relevant. In other words, data may be ranked according to relevance based on source, as well as its intended purpose. According to an aspect of the invention, data may be ranked according to certain ‘tiers’ representing the quality of data publication. For instance, a news service such as Reuters may considered a highly reliable source of data, and consequently be at a “top tier” source, whereas web blogs may be at a lower tier or not considered reliable at all.

At this stage, the data, albeit relevant, is typically still in an unstructured state. It therefore undergoes information structuring 608, performed by the information capture module 402 and information processor 406 according to one or more of the modules described above. If necessary, new profile categories may then be defined 610 based on the data. Typically, this will happen when the information is considered not to fit into any already defined profile(s). The profiles are then populated with the structured data 612 by creating links between one or more data elements under the profile heading.

Alternatively, data may be fed directly into the profiles module from another structured data source, most typically in the form of a feedback from the scenario or themes module of server 302. The dotted box containing the assessment 408, profiles 409, scenarios 410 and themes 412 modules, shown in FIG. 4, indicates that there is some flexibility in the way the modules can interact, and that there exists feedback between each of the modules, rather than a linear data exchange between one and the next module.

Profiles may be broadly defined as data categories defining ‘Historical Aspects’ of a given subject, person or organisation of interest. The source data assessment provides Current Data, but a profile, according to embodiments of the present invention, takes that understanding of what is going on and turns it into Historical Aspect data by placing it into the context of history and/or business objectives and/or other associations. More specifically, a profile is an object of information made up of a number of constituents (content, metadata etc.) linked to evidence or other pieces of supporting information, in this case information contained in one or more data elements 504 linked under a common heading representing any category of interest. Typical examples of profile category are: companies, Industry types, individuals, political affiliations, geographic locations etc. However, the types of profiles used will largely depend on the individual business objectives 420 of any given user. For example, the profiles may be populated with purely factual data, such as official reports, but may also, or alternatively, be populated with written opinions, which may not necessarily be factually correct but are still considered relevant to a given profile in deciphering relevant/useful information. According to an aspect of the invention, factual data is managed separately from non-factual data (e.g. the opinions of one or many users, unverified information etc.) without losing the close links between the two. Profiles may contain additional data from that provided by the source information, such as photographs, video clips and other digital media. In other words, profiles may contain any type or amount of targeted content.

It is also an aspect of profiling, according to embodiments of the invention, that periodic assessments (and even scores if necessary) can be applied to the information over time. This allows changes in the derived knowledge to be plotted on trend graphs, which can then be compared and contrasted with other profile trends as required. This aspect of profiling is applied to Theme monitoring in particular, which is described in more detail below.

One of the functions of the profiles module 409 is the itemisation and/or aggregation of profile information to enable a situational picture to be broken down or widened to suit a particular information need. This ability also helps with executive reporting of what is known, where multiple profiles can be grouped and summarised at the aggregated level. However, aggregating profiles does not necessarily conform to a strict hierarchy of information, since one profile (or “Dot of Knowledge”) may contribute to the summary of multiple profile aggregations, depending upon the desired viewpoint being analysed or reported on.

Preferred embodiments of the present invention use at least five basic types of profiles, each designed to support a specific task or knowledge requirement and each based on the principles as explained below. The skilled reader will appreciate that each type is derived from the same basic structure of a baseline profile description and that variations of each type are also possible but for illustration purposes only the most common usage is explained here.

### “Dot of Knowledge” Profile

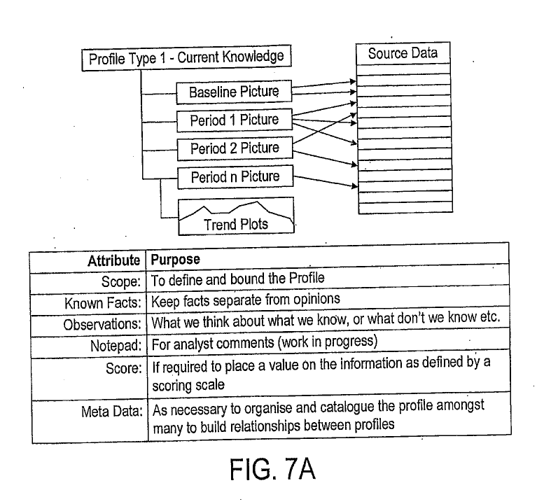

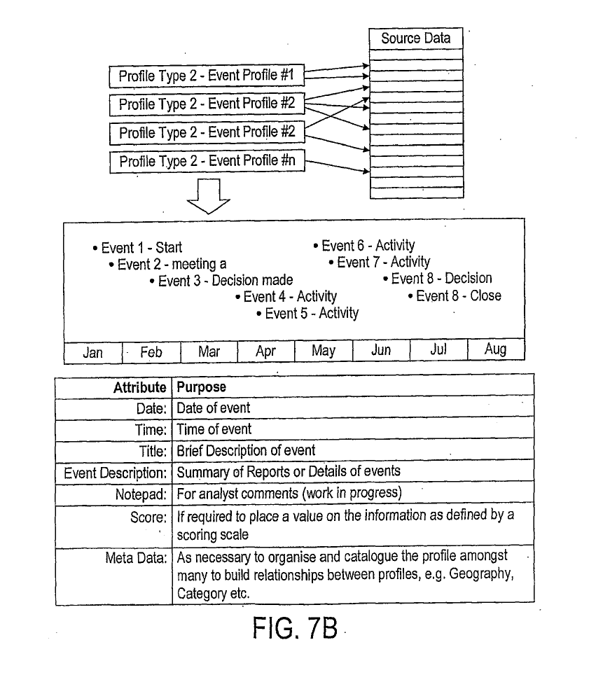

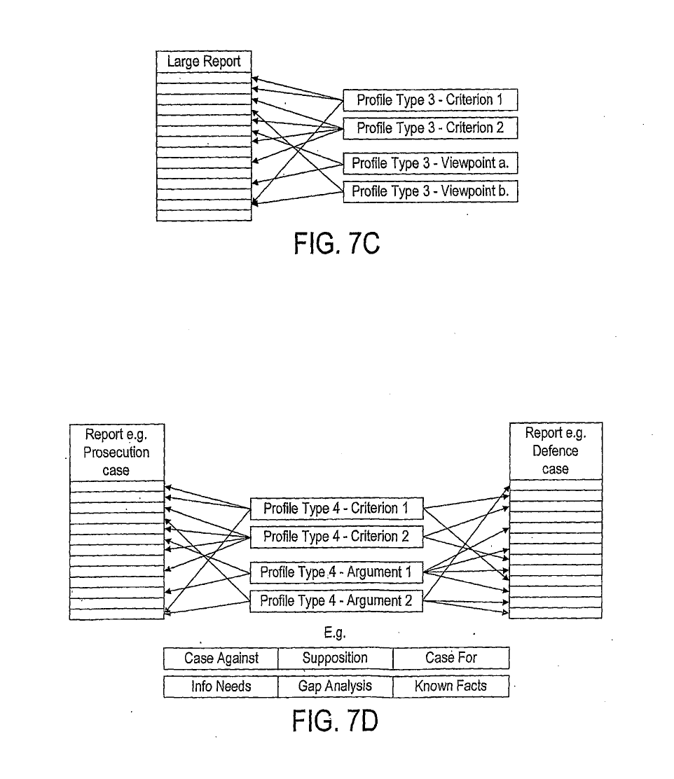

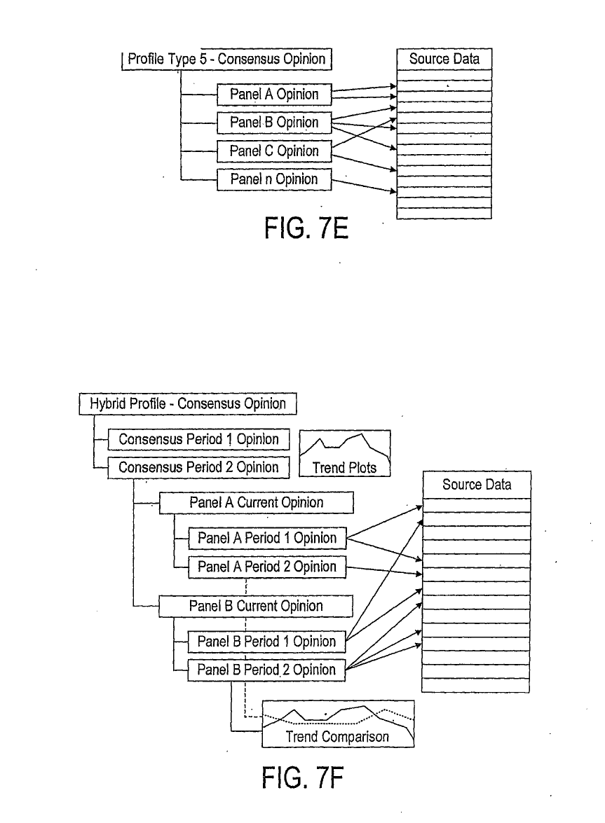

FIG. 7A shows a first kind of exemplary profile used by embodiments of the present invention, also known as a “dot of knowledge” profile. This profile type consists of an object of information with typically, but not limited to, the attributes shown in the table underneath the profile illustration as an example. A dot of knowledge profile comprises one or more linked data elements 504, as evidence of its correctness, or uncertainty, as the case may be. A profile may have multiple images in different periods.

Each dot of knowledge can link to evidence and source material at the sentence/paragraph level (or at the level appropriate for the content source in question) to the type of data being sourced within source documents, whilst accessing the associated meta data that has been assigned to the document as a whole, e.g. Date, Time and Source of publication (Elements of Data). Dot of Knowledge profiles can be base-lined and then regularly reappraised and assessed/scored against a criterion (which is generally a theme based on one or more predetermined objectives 420) to keep the ‘picture’, or information accrued, current. Data can then be extracted from these base-lines to produce, for example, a record of change over time and trend graphs (if figures are available) depending on the requirement of the user.

### Event Profile

FIG. 7B shows an “event profile”. This type of profile is similar to the dot of knowledge profile shown in FIG. 7A but is instead specifically reserved for events and occurrences on a particular date, or over a particular period. As above, the event profiles are linked to evidence and source material from data elements 504. It comprises a different set of attributes, an example of which is presented in the table underneath the event profile illustration. Event profiles collectively represent a chronology of events arranged in date order, which can then be plotted on a timeline. These can then be the subject of detailed analysis processes such as: thread analysis—e.g. in the analysis of what happened, by whom, in what order, over what time period; analysis of effects proliferation and responsiveness, to actions analysis—including worldwide coverage if the appropriate meta data is also attached to each event; and effects based monitoring compared with predictions for example. Another example of use for the event profile is to present evidence of a particular event from different sources so they can be viewed side by side to show how the same event is reported differently, or for example highlight inconsistencies in witness statements etc.

### Condensing Profile

FIG. 7C shows a “condensing profile”. This type of profile is typically used to reduce large documents down to manageable portions of information in the form of either an executive summary centred around a particular area of interest, or to represent the same document but in a different order and in a much condensed format. The reordering of the document could, for example, be against specific criteria that match other point of truth profiles and so these profiles could support the building of dot of knowledge profiles, and become the supportive evidence acting as the stepping stone to the source data. Further uses of this type of profile include viewing a piece of information from different viewpoints in order to compare and contrast, and support detailed analysis of events in the past or test “What-Ifs” where assumptions are added to the profile and managed. This type of profile is used for Scenario modelling which is also described later. Example profile criteria are shown in FIG. 7C, however, this is for the purposes of illustration only and should accordingly not be construed as limiting.

### Compare and Contrast Profile

FIG. 7D shows a “compare and contrast profile”. This type of profile is used to compare two or more documents or sources of information against a single criterion represented by the profile itself. For example, it may be desirable to compare and contrast two separate interpretations of an event from a number of different perspectives. This can be done by comparing and contrasting what each author of the document has said in order to establish what the actual truth might be. This type of profile can also be used to undertake gap analysis, i.e. determining what data is missing from profiles, which can then be reassessed periodically over time as and when new information becomes available. The gaps identified can inform the data collection plan and form the basis of new or updated data elements and/or profiles. Example profile criteria are shown in FIG. 7D, however, this is for the purposes of illustration only and should accordingly not be construed as limiting.

### Aggregation Profile

FIG. 7E shows an “aggregation profile” which is a type of profile used for collecting and comparing opinions and observations in order to derive a consensus opinion against a common criterion. For example, panel A may represent a team of analysts operating a system according to embodiments of the present invention in Europe and panel B may represent a team of analysts operating the system in Asia. By using profiles of this type, it is possible to conglomerate analytical data against common criteria across one or more systems spanning a number of locations where consensus reporting is sought. This type of profile is used particularly in Scenario modelling where a number of options or possibilities are tested against criteria in order to deduce which is the most favourable, for example. (See Scenarios which are described later). Example profile criteria are shown in FIG. 7E, however, this is for the purposes of illustration only and should accordingly not be construed as limiting.

### Hybrid Profile

FIG. 7F shows an example of a “hybrid profile” which represents combinations of the above profile types. For example, a point of truth profile that provides current data and maps the changes to that understanding over time, can be combined with an aggregation profile such that the Current Data can be derived from a consensus of opinion from a number of analysts or teams that could, for instance be geographically dispersed around the globe or be aggregated from a number of different teams working independently using the same data. This type of profile is used to monitor Themes over time as part of a continuous assessment process. (See Themes, which are described later). Example profile criteria are shown in FIG. 7D, however, this is for the purposes of illustration only and should accordingly not be construed as limiting.

### Visualisation of Profiled Information

The profiles module 408 is intrinsically linked with the data linking module 407, and is operable to link one or more profiles and thus create a mapping of relationships between profiles. This facilitates creation of alternative profiles to support a specific subject for analysis, or creation of scenarios. In other words, Dots of Knowledge can joined up to create larger Dots of Knowledge, where each dot can be used to support more than one high level profile. It is important to note that inter-profile relationships in this sense are not simple data hierarchies, rather they may form multi-faceted and complex relationships, particularly when linking and/or merging mixed profile types. According to aspects of the present invention, complicated relationship diagrams can be created, each with a particular focus on the client's specific information needs. Furthermore, profiles can be re-used many times so that a many-to-many relationship exists between all types of profiles. To manage this complexity a set of one or more “umbrella” or parent profiles (not shown) are typically used to collect related profiles together under a common theme, scenario or intelligence need. This allows comparing temporally separate profiles in the context of a given objective.

### Management of Profiled Information

The profiles module 408 is also operable to make sure the profiles which are typically stored in the non-volatile memory of the computer, are updated continuously. Due to the fact that knowledge and information is degradable in the sense that its value changes as the environment and surrounding situation changes over time, all relevant profiles are “refreshed” and validated periodically to ensure currency is maintained. The process of keeping all profiles current may be highly computationally demanding or highly laborious for a system operator, and may not be necessary given the specific information needs at any particular instant. Therefore, according to aspects of the present invention, profiles are preferably categorized according to their status and need, e.g. a “dormant” profile can remain un-reviewed until such time as it is necessary to revisit it, at which time the profile is updated and its currency renewed. In this ‘update’ situation when a profile is taken out of its dormant state, the profiles module will automatically signal the data acquisition module 403 to begin searching for new data relevant to the profile—and allow the operator to specify further searches including for related or linked profiles. In contrast, a profile may be categorized as being “on guard”, indicating that the knowledge held by that profile is constantly kept up to date and relevant to the client's specific needs and linked to the new evidence captured and catalogued in the source modules.

The profiles are constantly monitored and updated through the profiles module 409 to reflect recent or changing events, or changes made to the objectives, profiles, scenarios and/or themes. In this regard, there is a multi-level feedback between the objectives 420, profiles module, scenarios module and themes module.

According to an embodiment of the present invention, a historical archive of profiles is kept over time, e.g. in a database, or some other suitable data store, residing on the server 302. This process of archiving is referred to, as ‘base lining’. In general, the profile archive is a selection of profiles kept for permanent or long-term preservation and may be reviewed periodically, at predefined times or after any changes to the understanding of a situation is detected during the data capture and assessment activity. This enables, for example, changes to be tracked and analysed, and decisions to be revisited based on what was known at the time the original decision was taken.

### Introducing Conjecture to a Profile

In addition to simple attribute information that records opinions and observations of a profile alongside facts, it is often desirable to test a series of “What-Ifs” based on what is known but with assumptions introduced in a managed way to cater for uncertainty or gaps in knowledge. This can be done by linking the profile to assumptions recorded in an Assumptions Management Module, which in this example is part of the suite of tools held within the Data Management Tools Module 413.

The outputs of the profiles module typically feed into the scenarios module 410. A scenario is a predefined synopsis of a projected course of action, series of events or situations (usually containing conjecture), which may be used, for instance, in policy planning, business, development and strategy testing. A scenario may be predictive, i.e. for predicting outcomes or events. Alternatively, a scenario may also be used in hindsight in order to determine what happened or what might have happened leading up to a given event or outcome. A scenario is most commonly a merging or linking of one or more profiles, which may also include conjecture, and are used to establish and analyse options, identify risk or opportunity and establish answers to inquiry.

Thus the scenarios are any conceivable situations and/or problems that may occur for a given campaign or project. Usually, a scenario will combine known facts about the past or future, such as geography, military, political or industrial information, demographics etc., with probable alternative social, technical, economic and political outcomes. Scenarios are populated with profile data, assumptions and individual data elements 504, as well as objectives to define the purpose of the scenario

A typical exemplary use of the scenarios module 410 is in aiding decision makers in anticipating hidden weaknesses and inflexibilities in businesses methods for example, and can include anticipatory elements such as subjective interpretations of facts, changes in values, new regulations or inventions. In other words, scenarios may be used to comprehend or predict the different ways in which future events could occur in business, based on data element inputs, business objectives or other criteria. This is known as “scenario planning”.

A key element of scenario planning is the identification of risks to be mitigated or opportunities to be exploited. This is supported by the risk management and analysis tools from the data management tools module 413. The outputs of this activity will typically then be used to develop options which are then tested against the Historical Aspects accrued. Where there is uncertainty or gaps in that knowledge, the data collection plan is adjusted to find the missing data, which then filters its way up through the system to inform the scenario modelling and options analysis activity (See FIGS. 1 and 2).

Option analysis and decision support tools from the data management tools module 413 come into effect to identify the preferred option and support the decision. However, it is not always the case that high levels of sophistication are necessary to make a decision, and so these tools are only called upon if requested. This part of the process can be manually intensive so the system of the invention is designed to present the user with only the tools and functionality necessary for the intended application. In the disclosed embodiment of this invention that user is guided through the development of scenarios via a process which may be termed “Structured Thinking”.

In defining scenarios it is first necessary to decide on a key question to be answered by the analysis process or to look at an overall scenario that describes the end point, whether it is a desired end point or worst case scenario. An example of a scenario could be “Dispute with company X due to A, B and C, resulting in Q, R and S for the company”. A, B and C could be profiles with conjecture or risks captured in the risk/opportunity register, bearing in mind that both an assumption and a risk/opportunity entry in the register are in effect profiles similar to an event profile but with different attribute definitions and values.

The aim of the structured thinking code is to guide the user through the process to ensure each scenario (including option plans) is consistently defined and broken down into regular component parts so that information can be easily managed and linked, not only back to the source information used to derive the scenario, but also to the themes that will be used to monitor the effectiveness of actions and decisions taken. For example, part of the option planning process is the identification of success indicators and warning signs, that can be observed and measured to provide the ability to monitor progress effectively. These indicators can be used to derive the Themes that are monitored for the scenario.

Feedback from the themes module can be summarised alongside the scenario so that the current situation can easily be compared to the baseline scenario that led to the decision to act. Variances can then be acted upon and the effectiveness of these corrective actions can also be recorded and managed alongside the scenario data, informed by existing themes or new themes.

According to aspects of the present invention, scenarios may not lead to actions or decisions, but instead are used to facilitate the identification of research needs. Thus, based on the scenarios, it is possible to assess where more information is needed for a better understanding of the problem being addressed. Therefore, upon analysis of one or more scenarios, it may be concluded that more information is needed, for example, on the motivations of certain individuals. It may then be preferable or necessary to update the one or more profiles using data from open or internal sources according to the methods described above. In this regard, there is a feedback linking the scenarios and profiles, wherein changes to one are reflected in the other. In this way, scenario data can become a source of internal data which can be used in order to further populate and/or change profile data using one or more additional data elements, or alternatively, to remove data elements from a given profile that are no longer necessary or relevant.

The themes module 412 is, according to one embodiment, operable to act as a monitor for the constantly changing situation and operating environment of the user/client and can be used to keep profiles and scenarios current, as well as inform the user directly of trends in any particular topic of interest. More specifically, the themes module 412 enables a user or system operator to determine the effectiveness of actions taken and/or the consequences of events over time and track changes with an overall project or campaign view.

The purpose of the Themes module therefore, can be defined as providing “Monitor and Control” through the continuous monitoring and repeated scoring of criterion predominantly based on pre-defined success indicators and warning signs in view of actions taken and the desired effects on an overall campaign or project. Analysis of the trend information produced can then determine what changes need to be made to the one or more scenarios and plans developed in the Scenarios module in order to influence further actions, or even gain a better understanding of the consequences of the actions taken by a competitor or other third party that may impact on the business, or the market place trends.

Ultimately, theme analysis is used by individuals or organisations to adjust actions and responsiveness to events based on up to date information and knowledge, but it can also be used retrospectively to assist in inquiry by producing multiple views of past events and decisions based on what was known at various points of time in history. This is facilitated by the information captured in a structured and highly organised manner, via information capture module 402, the assessment of that information via assessment module 408, and the profiles produced via the profiles module 409, all of which can be sorted and interrogated in date order. Thus, the user can build up case studies to determine lessons learned, and then continue to monitor the implementation of those lessons, taking the past and projecting it into current and future actions.

Trend information produced by themes can be compared and contrasted to identify causes and effects across criteria, e.g. criterion X shows a downward trend whilst criterion Y shows an upward trend. By comparing and contrasting trends it is possible to identify if there is connection between criteria, and if so which one is driving the other. Such analysis may lead to additional themes or criterion to be monitored in order to derive the answer to these questions. Furthermore, trends can be extrapolated to predict the future and therefore can inform the development of scenarios and mitigation plans etc. Continued monitoring can show whether the assumptions made or risks identified, which are managed in data management tools module 413, were correct or not.

Thus embodiments of the present invention allow repeatable assessments where the principles and functionality listed below apply, based on best practise as applied to multi-criterion assessments of options. It should be noted here that these aspects are implemented via the decision support tool within the Data Management Tools Module 413 and are also applied to the scenarios module 410 when undertaking option analysis and selection. The additional functionality the Themes module 412 employs is the repetition of the assessments and the subsequent ability to produce trend information for comparison and analysis.

Criterion Based: The assessments are criterion-based to allow multiple viewpoints and aspects to be considered in the assessments such that comparison of criterion trends and periodic evidence will yield additional knowledge specific to the information needs of the user.

Periodic Scoring via scorecards: Each criterion is assessed and scored at regular time intervals to facilitate the generation of trend graphs. Multiple scores can be assigned to each criterion for any period, if required, to further extend the value of the information generated. For example, uncertainty and confidence levels can be included in the scoring as well as others. The use of each score can be defined by the user to further extend the criteria or focus on a particular aspect during a specific period within the overall assessment programme. System generated scorecards will automatically manage the process in order to simplify and control the process across multiple users and sites. The use of the scorecards mainly facilitates the subjective assessments of the criteria.

Identify and capture Issues, Concerns, Opportunities and Risks: The scorecard may also facilitate the capture of any issues or concerns (or opportunities) identified for that criterion during each assessment period, and transfer that information to the appropriate data management tool, e.g. Risk Register, for subsequent management and input to profiles and scenarios etc.

Link to evidence and record rationale: The scorecard will also facilitate the linking to the evidence assessed during the period, and record the rationale for the scores awarded.

Continuous Assessment via Panels: The tool will be able to support multi user scoring, as well as individual scoring, where subject matter experts can organise themselves into teams from which consensus scoring can be obtained. Each panel of experts may represent a particular viewpoint for the same set of criterion to provide a further breakdown and level of detail required for analysis, or can be individually assigned to specific criterion depending upon their particular area of interest.

Multiple options assessed over time: The tool will also enable multiple options to be assessed against the same criteria, by the same panels to enable, for example, trends of performance between options to be compared and contrasted.

Periodic Scoring via Data Capture module: It should be noted that a significant amount of trend information can also be generated automatically from meta-data garnered from the data capture process without the need for human intervention and input. This information will supplement the human assessments and be more statistical and objective in nature.

Scoring Scales: Each criterion is scored against a pre-defined scoring scale, complete with sub-criteria, to ensure consistency and accuracy of scoring over time.

Normalisation of scores: The information processor has ability to normalise all scores to a standard scale of 0-100 in order to enable different criterion to be compared. Normalisation curves enable the user to adjust the way in which scales are normalised.

Weighting and Aggregation of Scores: Structure to criteria allows the scores for each criterion to be aggregated to provide an overview of the assessments, if required. To further improve the meaningfulness of such aggregation, each criterion can be weighted according to the user's input.

FIG. 8 illustrates a typical application of the Themes module 412, where the subject under study here is, for example, the effects of an explosion in an oil refinery. The three branches of the criteria represents the three aspects of the assessment; the assessment criteria itself, the panels or subject matter experts, and the options (or in this case different viewpoints). Each of the aspects of the assessment is also represented as the three dimensions of a cube, where each “building block” (constituent cube) represents a compact piece of information highly organised into a larger cube of assessed data.

The criteria shown is made up of two types of questions, subjective and statistical. It is an aspect of this invention that the statistical assessment is achieved via highly automated processes, with minimal human intervention to adjust the results and confirm the level of accuracy required.

Each, criterion is further defined by sub-criteria, scoring scales, and other attributed information (normalisation curves, assessors etc.) such that it an be used repeatedly without deviation over time.

The example criteria shown in FIG. 8 has been carefully designed to allow subsequent analysis of the findings of each assessment. For example, what are the differences in perception across the various contractors and/or agencies, and how does this affect the motivation of each group?. Furthermore, what is the driver for these perceptions, regional media, global media etc. and how can this be used to change perceptions?. It will be apparent to the reader skilled in the art that these highly organised data sets, garnered from, unstructured data sources and opinions, will yield lots of opportunities for detailed analysis of the overall picture, why it is as it is, how it can be changed (if at all) and how one should react or operate in that environment and so on.

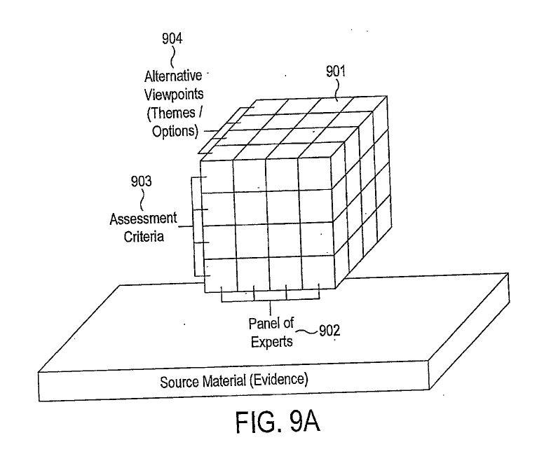

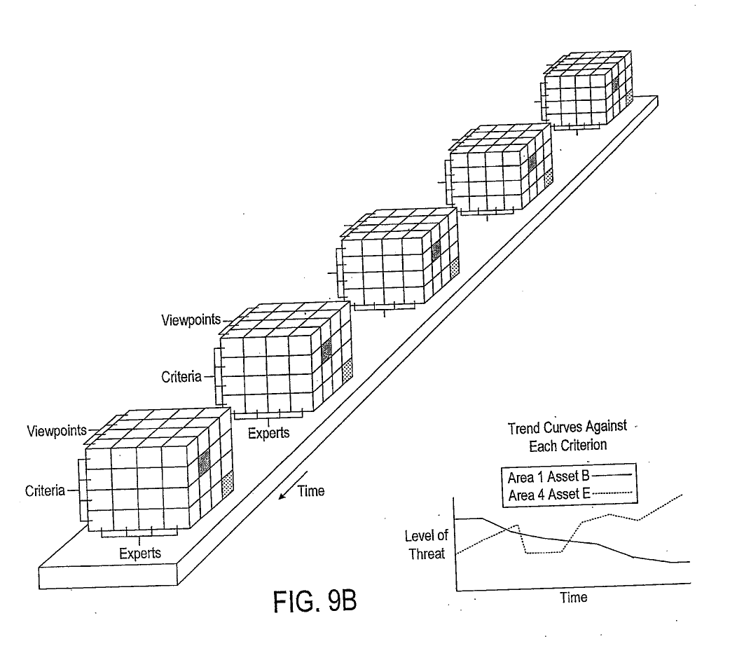

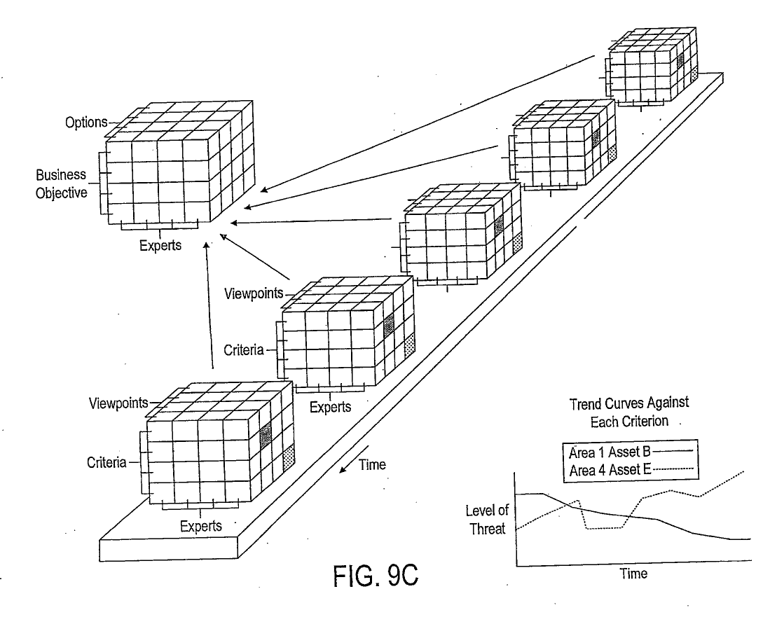

FIG. 9A shows a visual representation of relationships of data gathered according to the methods described above. The block 901, which is a conceptual device, represents a snapshot of data centred around a number of Themes, although it could easily apply to a set of profiles or scenario options as explained later. This cube of evidence represents the highly organised and structured data typical of the output of this system at a given instant in time for a given project. In this example, the cube of data represents the three aspects (or dimensions) of assessment as follows: the criteria 903 applied to the assessment, the subject matter experts 902 undertaking the assessment, and the different viewpoints (or options) 904, being assessed. Hence, each constituent cube in the diagram represents a subject matter expert's opinion and/or conclusions 902 about a particular option or viewpoint 904 that includes the criterion definition, scores and rationale for the marks awarded, as well as any issues, concerns and/or opportunities associated with that criterion 903. Each constituent cube of information is linked to the source data or evidence that was used for the assessment 905. The system is designed to manage this data and the assessment of it such that it can be repeated over a period of time to keep the results current based on new evidence or data captured as it is produced and published on the Internet, in the media, and such like.

FIG. 9B shows how several of these snapshots may be built up over time in order to monitor the situation and track changes in order to produce trend information for each constituent cube, which can be plotted to produce trend graphs for each expert's viewpoint for each criterion and option being assessed. These trend graphs can be compared and contrasted with each other to support further analysis of the information derived by the system, for example, to identify causes and effects of actions and reactions, comparisons of opinions from different parts of the globe and how they are responding to changing circumstances, and so on. Extrapolation of the trend information can provide an element of predictive analysis that is soundly based on good rationale and links to robust evidence that can be challenged if necessary at any time. The monitoring of themes in this way is designed to be real time or as near to real time as possible to enable decision makers to make robust decisions quickly, whilst at the same time being able to monitor the effectiveness and impact of previous decisions such that corrective action, if required, can also be taken quickly.

Given that the whole system and processes therein are iterative and ongoing, it is possible to quickly build up a bank of trend knowledge that is specific to the user's specific business objectives. This knowledge can be revisited and utilised at any time for other core business activities. For example, the development of scenarios and options as described for sub-system 3 (see above). Furthermore, the same assessment process and tools can be used as a single activity to assess the options against a common criteria in order to better inform the decision making process.

FIG. 9C shows how the snapshots and trend analysis may be used in order to impact business decision making where a number of options (courses of actions for instance) is being assessed by a panel of experts based on the market trend information which the system has also captured and linked to the source evidence. Thus by assessing the trends of profile, scenario and theme data over time, a business can make informed decisions about its assets, objectives (and how to exploit opportunities or overcome anticipated threats) and areas of operation.

FIGS. 9A-C show only one illustrative example of how the embodiments of the present invention may be used in business decision making. However, the skilled person will recognise the countless possible applications of the present invention some of which are outlined further below.

The output application 414 creates the user interface to the server 302 through the automatic generation of code in response to pre-defined rules, or user inputs, and the utilisation of numerous visualisation techniques to present the data to the user and produce various reports and outputs.

According to an optional aspect of the present invention, where the system is used by more than one operator, it may be preferable to have predefined user permissions allowing certain users access to only certain parts of the system. For example, a researcher may only have access to control the information capture module, whereas an analyst or subject matter expert may have access to the entire system and a client may have access only to the reports generated by the system according to configurable rules.

According to an embodiment of the present invention, at every stage throughout the server 302, a script file (typically in XML format) will be produced by a script generator 416 which contains log data. These XML files can then be referenced by all other parts of the server 302. One example in which the XML files are used is in storing so-called “friend of a friend” (FOAF) attribute data in order to facilitate the production of relationship mapping diagrams. This may happen automatically or be carried out manually by a system operator, for example, by exporting data to customised visualisation tools to enhance analysis. Such applications form part of various embodiments of the invention and include integrated and interactive timelines, media proliferation maps, navigation tools and customised reporting.

The server 302 is preferably also provided with interfaces for communication with one or more other remote servers deployed at different locations, through which data can be shared. In this way, therefore, it is possible for the system of the present invention to be deployed across various geographic locations and operated, for example, by various undertakings or agencies, that are able to share data across a common platform.

According to one aspect of the present invention, this structure is represented in graphical format and output through a user interface via output application 414. The interface may be a structure of linked text strings but alternatively icons may be used to represent any of the themes, scenarios, profiles and/or data elements as required. Through the interface, a system operator is able to see an overview of the entire project or campaign. Within the graphical representation, each text string may be linked such that it is associated with the respective theme, scenario, profile or data element. It thus allows a user to easily view or edit the respective theme, scenario, profile or data element by calling up the relevant module 408 to 412.

An example of a typical output produced by the output application according to one embodiment of the present invention is an interactive user interface which takes inputs from one or more of the themes, scenarios and/profiles modules and produces a visualised report that readily supports further analysis by the operator. The system supports the analysis process and the results of any analysis are captured within, or alongside the assessed material, which is itself linked to captured evidence to provide robustness and enable the capture and sharing of information in a controlled environment.

A typical report is provided by the output application in HTML format, and is viewable with a conventional desktop web-browser. However, it will be apparent to the skilled reader that reports generated in accordance with embodiments of the present invention can be generated in various formats, e.g. PDF, Word document and other interactive electronic formats, as well as non-electronic formats. The analysis report includes for example a title, a time scale and one or more hyperlinked data entries. The data entries may be placed automatically according to an appropriate method of organisation, for example, in chronological order along a time line, according to the value ‘D’ present in element 504. In this way, each hyperlinked data entry is logically associated with the corresponding data element.

Although chronological ordering of data elements has been provided as an example, it will be appreciated that any ordering scheme may be employed using any project elements within the scope of the present invention. For example, data entries may be ordered according to a relevance rating or scenario entries may be ordered according to severity etc. Optionally, one or more additional graphical representations in the form of charts may be provided, such charts illustrating selected characteristics of the data entries. For example, a line graph may indicate the activity density over time, where activity density represents the number of data entries at a given point in time. This may be useful in, scenario analysis, where fluctuations in overall activity may be indicative of important changes. Alternatively, textual summaries or summaries presented in data tables may be used. Alternatively, data may be provided graphically on a world map, showing the geographic location of data and a worldwide view of a project or event.

A report output is preferably generated by the output application 414 in two ways: firstly, to a suitable web-format at a given secure URL for use by customers, i.e. the representatives of companies for whom information has been gathered; secondly, as local output in one of the following formats—common office formats such as DOC, PDF, PPT, XLS, as well as common web formats such as HTML, RSS, PNG, JPEG and suchlike. In addition, outputs may also include KML file information for describing three-dimensional geospatial data and its display in applications such as Google Earth.

The generated output of the system will immediately start to deteriorate in value over time at varying degrees of rate depending upon the use of that report and the stability of the business environment. Therefore, the system is design to capture the outputs, in report form such that they themselves become captured as internally sourced material and used to continue the build up and utilisation of knowledge. As mentioned previously, the server 302 is designed to be integrated and iterative. Therefore, there is only an entry point, but no exit points in the process diagram at FIG. 1, only feedback loops (unless the user decides to cease its employment and operation for a particular project or campaign). However, in any event, the body of knowledge accrued is still valuable to the user, and will only ever be in a “Dormant” state because it could always be revived from the archive and brought up to date quickly at any time in the future based on new data captured by the sub-system 1.

### Example Applications of Embodiments of the Invention

The following is a set of suggested uses of this invention by different organisations or users. Each one may only utilise a single sub-system at a time, or may employ the full functionality of the system. FIG. 2 will be referred to here to provide the link between the activities undertaken by an organisation and the functionality of the invention to support those endeavours.

The examples provided here are just simple examples of application, and the reader experienced in these matters will quickly appreciate the widespread application and utility of this invention.

A Public Relations company or Market researchers may only avail themselves of the functionality of sub-system 1 (see FIG. 2, 102) to gain current understanding. Media monitoring to measure and track the spread and proliferation of key messages and/or bad news is one example of its use, as well as the creation of profiled information to identify relationships and gaps in knowledge and help target better the data collection activity. For example, in determining who are the key players or organisations that actually shape the operating environment, and what motivates them. Market Researchers may use this to test the temperature of market sectors, and gauge the current mood etc.

Legal firms and Investigators (police, private detectives, and inquiry panels etc.) may wish to utilise sub-system 2 (see FIG. 2, 103), building upon the data capture and assessment capability of 102, to introduce conjecture and “what-ifs” into the profiled knowledge in order to target the data collection activity and test theories against the new evidence being collected, for example what might have happened, or what lessons could be leaned. According to one example, companies that deal in speculation are be able to back up their claims with robust evidence and analysis thereby adding value to their product. This is taking the same functionality of the system but applying it to the future, rather than past events.

All companies need to make major investment decisions at times, or test their strategies against the projected market. Accordingly, campaign planners will wish to develop contingency plans based on risk and opportunities, and legal firms will wish to build a number of scenarios and test them against the likelihood of success and/or credibility in court. These activities are supported by sub-system 3 (see FIG. 2, 104).

Theme monitoring can be employed to measure the effectiveness of actions taken by the company as a whole, or simply as a corporate reporting mechanism on project performance, for example. Department performance can be compared and contrasted with each other in the context of their particular operating environment in order to tease out the issues and improve the overall performance of the business. Companies that specialise in change management would find the embodiments of the invention a useful tool to measure the success of the change programme and pin-point where the issues really are and be able to identify causes and effects to resolve them. An example of a criteria for internal performance monitoring would be a team's ability to manage, compared with progress against the plan, compared with the actual results being achieved. These simple but effective criteria could be applied to each department within a company, across regional sectors of a company, or across different industries etc.

Security agencies may apply this capability to their efforts to detect and track insurgent activity, and provide a mechanism for operatives to pool and share their knowledge in a secure and controlled way.

Those skilled in the art will recognise that the invention has a broad range of applications in many different types of information assessment and analysis applications, and that the embodiments of the present invention described in this disclosure may take a wide range of modifications without departing from the inventive concept as defined in the appended claims. For example the present invention may be deployed in the fields of law, PR, hedge funds, mergers and acquisitions, trading, security and so on.

1. A computer implemented document processor comprising:
an information capture module configured with an interface to multiple document sources and to capture a plurality of data elements from documents sourced;
an interface for receiving objectives and/or criteria;
an information processor comprising an assessment module operable to analyse and assess a current state indicated by said data elements;
one or more of: a profiles module; a scenario module; and a themes module;
a memory; and
an output module.

2. A computer implemented document processor according to claim 1, further comprising a visualisation module.

3. A computer implemented document processor according to any preceding claim, and wherein the information capture module sources documents according to received objectives and/or criteria.

4. A computer implemented document processor according to any preceding claim, wherein the information capture module is configured to source documents from public document sources.

5. A computer implemented document processor according to any preceding claim, wherein the information capture module is configured to source documents from one or more private document sources.

6. A computer implemented document processor according to any preceding claim, comprising one or more of: a data acquisition module; a data splitting module; and a tagging module.

7. A computer implemented document processor according to any preceding claim, wherein the information capture module comprises a Webcrawler device.

8. A computer implemented document processor according to any preceding claim, comprising a data splitting module operable to split documents into data elements each comprising an information item from a document.

9. A computer implemented document processor of claim 8, further operable to generate metadata associated with each said data element.

10. A computer implemented document processor of claim 9, wherein the metadata comprises one or more of: a label or a keyword.

11. A computer implemented document processor of claim 10, wherein a label comprises one or more of: title; source; and date.

12. A computer implemented document processor of claim 10 or 11, wherein a keyword comprises one or more of: a geographic location; author; organisation; and an indication of context.

13. A computer implemented document processor according to any preceding claim, wherein a data element is logically associated with a source document.

14. A computer implemented document processor according to any preceding claim, comprising an assessment module operable to process a data element and associate it with one or more of: a relevance score; a non-numerical ranking; a numerical ranking; a confident score; opinion; a commentary; a user objective; and a user criteria.

15. A computer implemented document processor according to any preceding claim, comprising an assessment module and a profiles module, wherein the profiles module is configured to receive outputs from the assessment module to populate one or more profiles.

16. A computer implemented document processor according to claim 15, wherein a profile comprises an object of information and information about its context.

17. A computer implemented document processor according to claim 15 or 16, wherein a profile comprises links to least one data element.

18. A computer implemented document processor according to claim 15, 16 or 17, comprising a data linking module configured to establish links between profiles and data elements.

19. A computer implemented document processor according to claim 15, 16, 17 or 18, wherein a profile comprises a plurality of attributes.

20. A computer implemented document processor according to any preceding claim, comprising a stored profile selected from one or more of the following profile types: dot of knowledge profile; event profile; condensing profile; compare and contrast profile; aggregation profile; and a combination of two or more of the aforesaid profile types.

21. A computer implemented document processor according to any preceding claim, comprising a data linking module and a profiles module, and operable to create and/or map relationships between first and second profiles.

22. A computer implemented document processor according to any preceding claim, comprising a profiles module and wherein one more of a data element, or a profile can be selectively indicated to be dormant or live.

23. A computer implemented document processor according to any preceding claim, comprising a profiles module and wherein a profile comprises an association with one or more of: opinion; observation; assumption.

24. A computer implemented document processor according to any preceding claim, comprising a scenarios module, wherein the scenarios module is configured to define scenarios comprised of one or more of: a projected course of action; a series of facts; a series of events; and a series of situations.

25. A computer implemented document processor according to claim 24, comprising a scenario populated by profile data.

26. A computer implemented document processor according to any preceding claim, comprising a themes module, wherein the themes module is configured to construct a theme based on scenario data.

27. A computer implemented document processor according to claim 26, wherein the themes module is configurable to perform monitoring according to one or more of the following techniques: criterion based; panel-based assessment; and multiple options over time.

28. A computer implemented document processor according to claim 26 or 27, wherein the themes module is configurable to contribute to visual representations according to a plurality of themes.

29. A computer implemented document processor according to any of claim 26, 27 or 28, configurable such that a theme is monitored in multiple dimensions.

30. A computer implemented document processor according to any of claims 26 to 29, configurable such that a plurality of multidimensional themes can be monitored simultaneously.

31. A computer implemented document processor of any of claims 26 to 30, configurable such that a plurality of multidimensional themes can be monitored over time.

32. A computer implemented document processor according to any of claims 26-31, configurable such that theme are monitored in multiple time dimensions.

33. A computer implemented document processor according to any of claims 26-32, configurable such that themes are monitored in multiple geographic locations.

34. A computer implemented document processor according to any preceding claim, comprising a visualisation unit capable of presenting results graphically, and wherein said visualisation module is configurable to present graphically: a data item; a relationship between data items; a trend; or a geographic proliferation, said result relating to one or more of: a profile; a scenario, and a theme.

35. A computer implemented document processor according to any preceding claim, comprising a data management tools module including one or more of: scenario planning device; a risk management device; options analysis device; structured thinking tools.

36. A computer implemented document processor according to claim 35, wherein the data management tool module supports setting of one or more of success indicators and warning signs in a scenario or theme.

37. A computer implemented document processor according to claim 1 or 2, wherein an output of one or more of said: profiles module; scenario module; themes module; visualisation module; and output module, is supplied to the information capture module.

38. A computer implemented document processor according to claim 1 or 2, wherein an output of one or more of said: information capture module; scenario module; themes module; visualisation module; and output module, is supplied to the profiles module.

39. A computer implemented document processor according to claim 1 or 2, wherein an output of one or more of said: information capture module; profiles module; themes module; visualisation module; and output module, is supplied to the scenarios module.

40. A computer implemented document processor according to claim 1 or 2, wherein an output of one or more of said: information capture module; profiles module; scenario module; visualisation module; and output module, is supplied to the themes module.

41. A computer implemented document processor according to claim 1 or 2, wherein an output of one or more of said: information capture module; profiles module; scenario module; themes module; and output module, is supplied to the visualisation module.

42. A computer implemented document processor according to claim 1 or 2, wherein an output of one or more of said: information capture module; profiles module; scenario module; themes module; and visualisation module, is supplied to the output module.

43. A computer implemented document processor according to claim 1 or 2, wherein an output of one or more of: said profiles module; scenario module; themes module; visualisation module; and output module, is supplied to the information capture module.

44. A computer implemented document processor according to any preceding claim, comprising a remote server interface configured for the exchange of results data and analyses to/from a remote data management computer.

45. A method of operating a document processing system according to any preceding claim.

46. A method of operating a computer to perform a document processing task, comprising:
receiving documents comprising information and splitting each document into a plurality of data elements;
building profiles, each profile being connected to a plurality of data elements;
constructing scenarios and/or options based on one or more of said data elements and profiles;
monitoring themes constructed using one or more of said data elements, scenarios, and themes;
outputting a visualisation of results.

47. A computer program comprising programme code, said programme code being operable to cause a computer to perform a method according to claim 46.

48. A computer program recorded on computer readable medium, said computer program comprising programme code operable to cause a computer to perform a method according to claim 46.
